(19) United States
(12) Patent Application Publication
(10) Pub. No.: US 2021/0157157 A1
(43) Pub. Date: May 27, 2021

(54) Thee-Dimensional Display Using Optical Fibers

(71) Applicant: Samir Moufawad Moufawad, Mazraat Yashouh (LB)

(72) Inventor: Samir Moufawad Moufawad, Mazraat Yashouh (LB)

(21) Appl. No.: 16/690,202

(22) Filed: Nov. 21, 2019

(51) Int. Cl. G02B 27/22; G02B 6/42

(52) U.S. Cl. CPC G02B 27/2285; G02B 6/4201

(57) ABSTRACT

A three-dimensional display consists of a rotating body of optical fibers. Each fiber receives light on first end from a stationary light source, and re-emits the light on the second end when the light source is aligned during a time interval with first end of the fiber. During one revolution, each re-emitted light occupy a unique three-dimensional coordinate, thus all re-emitted lights form a three-dimensional image. Three-dimensional still or moving images are obtained by successive images produced on successive revolutions of the body of optical fibers.

### BACKGROUND OF THE INVENTION

### Field of the Invention

Embodiments of the invention described herein pertain to the three-dimensional displays. More particularly, but not by way of limitation, one or more embodiments of the invention enables a three-dimensional still or moving images display using rotating structure formed with optical fibers.

### Description of the Related Art

There are three-dimensional holographic and real displays. The present invention addresses real three-dimensional displays which are not well developed. This is due to the lack of the appropriate and practical technologies. The prior art inventions provide display technologies, however only in low resolution.

Some three-dimensional displays use rotating arrays of LEDs. While powering and controlling a low number of LEDs is possible, doing so for a high number of LEDs is difficult. Such displays pass power and control to a rotating structure containing the LEDs. But passing power and control generates friction and noise. And rotating a structure which includes a lot of LEDs and circuitry is not simple task.

It is possible to generate power by induction on the rotating structure. Also, it is possible to pass data and control via wireless means. But all this will result in a bulky, heavy and costly structure which needs to be rotated.

### BRIEF SUMMARY OF THE INVENTION

It is feasible to transfer power, data and control to a rotating mechanism which includes arrays of LEDs. But transferring power, data and control for thousands of rotating LEDs to obtain more resolution becomes difficult, costly and impractical. The present invention completely eliminates the need of any transfer being power, data or control. This is simply done by transferring only the desired lights themselves. While a structure containing the optical fibers rotates, light sources are stationary and receive their power and control by traditional means. The light sources can be arrays of LEDs, and LEDs on a Printed Circuit Board, Etc. Better yet, light sources can be pixels of any screen. And to better utilize the pixels of a screen, another optical fiber structure can convert the light of the pixels from x-y coordinates to light sources adapted to configurations suitable to the rotating structure.

Optical fibers provide a very practical media to transfer light. To obtain three-dimensional moving images, the structure containing the optical fibers is rotated while the light sources stay stationary. During first revolution, each one end of each fiber is aligned in a time interval with its corresponding light source. At this alignment time, the light source is turned on by the controller. Then, the light is transmitted through the fiber and is re-emitted to the other end of the fiber. One complete three-dimensional image is formed when the structure completes one revolution. All the fibers reemit their corresponding lights from their corresponding light sources. To form still or moving images, the second image is displayed during the second revolution and the third image during the third revolution and so on. As can be clearly seen that using optical fibers can provide the right technology needed for the developing of real three-dimensional still or moving images displays.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an exemplary optical fibers structure rotating around its vertical axis, and horizontally stationary light sources in accordance with the three-dimensional display described herein.

FIG. 1b illustrates an exemplary three-dimensional image with all fibers emitting light.

FIG. 2 illustrates an exemplary optical fibers structure rotating around its vertical axis, and vertically stationary light sources in accordance with the three-dimensional display described herein.

FIG. 2b illustrates an exemplary curved screen providing pixels as stationary light sources in accordance with the three-dimensional display described herein.

FIG. 3 illustrates an exemplary optical fibers structure rotating around its horizontal axis and stationary light sources which are the pixels of a screen in accordance with the three-dimensional display described herein.

FIG. 3b illustrates an exemplary three-dimensional image with all fibers emitting light in accordance with the three-dimensional display described herein.

FIG. 3c illustrates an exemplary diameter size of optical fibers which guarantee each optical fiber will receive light from at least one pixel of a screen in accordance with the three-dimensional display described herein.

FIG. 4 illustrates an exemplary optical fibers structure rotating around its vertical axis and horizontal stationary light sources receiving light from a second optical fibers structure which receives light from pixels in x-y coordinates of a screen in accordance with the three-dimensional display described herein.

FIG. 5 illustrates an exemplary optical fibers structure rotating around its vertical axis and vertically stationary light sources receiving light from a second optical fibers structure which receives light from pixels in x-y coordinates of a screen in accordance with the three-dimensional display described herein.

### DETAILED DESCRIPTION

The three-dimensional display will now be described using exemplary embodiments of the invention. It will be apparent to an ordinary skilled in the art person that the present invention may be practiced without incorporating all its aspects herein. Readers should note that although examples of the invention are set forth herein, the claims, and the full scope of any equivalents, are what define the metes and bounds of the inventions.

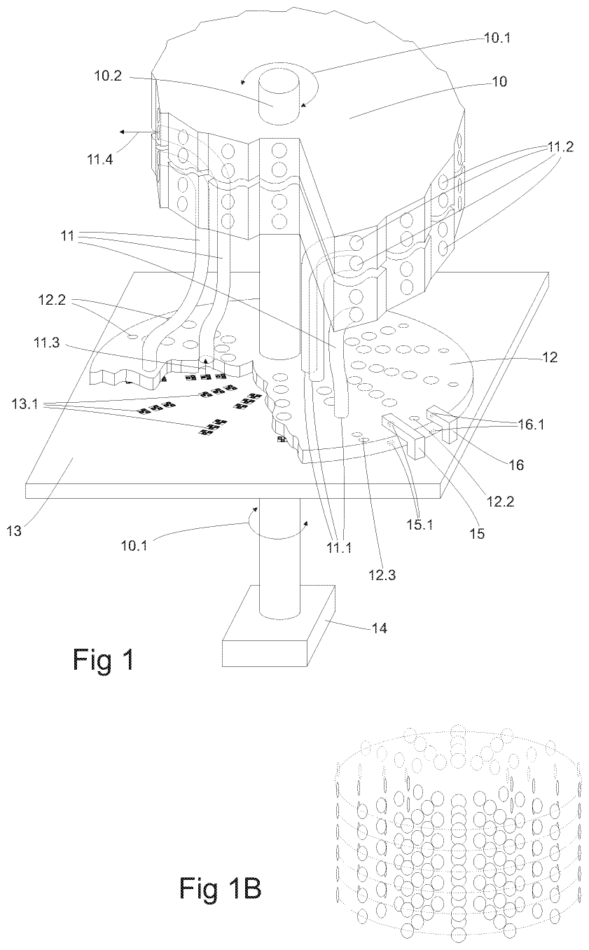

FIG. 1 illustrates an exemplary optical fibers structure rotating around its vertical axis, and horizontally stationary light sources in accordance with the three-dimensional display described herein.

Structure 10 comprises mainly of optical fibers 11, and it rotates around its axis 10.2 in either direction 10.1 by rotation means 14. Optical fibers 11 have first ends 11.1 which receive light and second ends 11.2 which emit light. Disk 12 is preferably opaque and supports first ends 11.1. Structure 10, disk 12 and optical fibers 11 rotate at the same angular velocity.

Board 13 is stationary and is perpendicular to the axis of rotation 10.2. Board 13 comprises mainly light sources 13.1 and sensors 15 and 16. As structure 10 rotates during one revolution, each light source 13.1 aligns with its corresponding first end 11.1 at certain time interval. At this time interval, light source 13.1 is powered with its desired intensity by a controller. Thus, this desired light such as 11.3, goes through first end 11.1 and is emitted from second end 11.2 such as 11.4.

Therefore, during the first revolution, all light sources 13.1 align with their corresponding first ends 11.1, each at its specific time interval. All second ends 11.2 will retransmit their channeled lights and form a three-dimensional image by the completion of the first revolution. A three-dimensional image is illustrated in FIG. 1b where all second ends are emitting lights.

Similarly, by the end of second revolution of structure 10, the second three-dimensional image is formed by second ends 11.2 remitting their channeled lights. To form still or moving images, the second image is displayed during the second revolution and the third image during the third revolution and so on.

The speed of rotation will determine the proper appearance of the moving images. To achieve much better appearance of each image, an accurate synchronization between light sources 13.1 and first ends 11.1 is done by using sensor 15. Sensor 15 has an emitter and a receiver 15. 1 which transmit and receive light through holes 12.2. As structure 10 rotates, holes 12.2 allow light to go through which triggers sensor 15. When sensor 15 is triggered, this means the corresponding light sources 13.1 are aligned with their corresponding first ends 11.1. At this time interval of alignment, light sources emit their desired lights which are channeled in the optical fibers 11 and finally emitted from second ends 11.2.

Another sensor 16 is used to determine the home position of structure 10. The home position can be used to know the start of each revolution and hence each image. Sensor 16 has an emitter and a receiver 16.1 which transmit and receive light through holes 12.3. As structure 10 rotates, holes 12.3 allow light to go through which triggers sensor 16. Sensor 16 can be used for other important positions of structure 10. This is done by adding more holes which sensor 16 can detect.

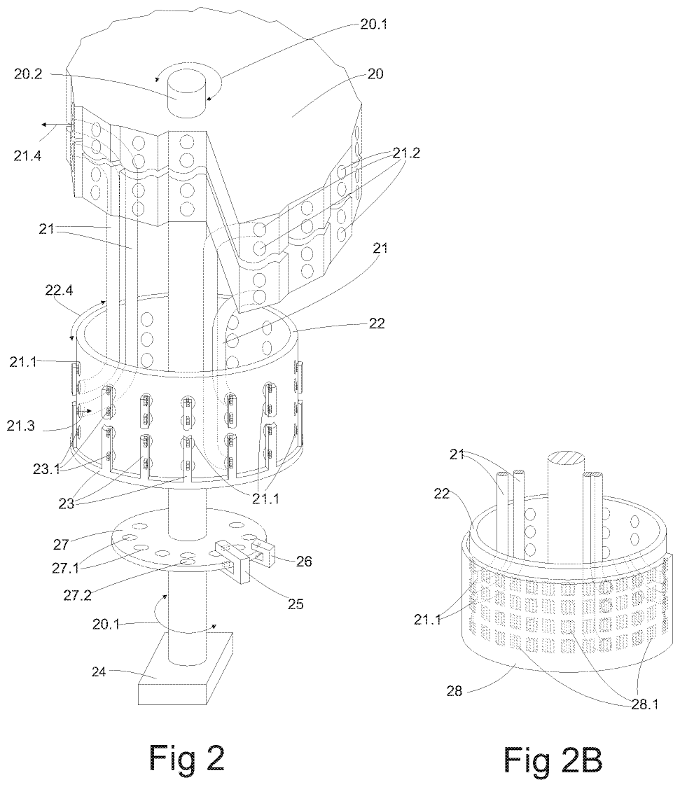

FIG. 2 illustrates an exemplary optical fibers structure rotating around its vertical axis, and vertically stationary light sources in accordance with the three-dimensional display described herein.

Structure 20 is similar to structure 10 and comprises mainly of optical fibers 21, and rotates around its axis 20.2 in either direction 20.1 by a rotation means 24. Optical fibers 21 have first ends 21.1 which receive light and second ends 21.2 which emit light. Cylinder 22 is preferably opaque and supports first ends 21.1. Disk 27 is opaque and has holes which interrupt the lights of sensors 25 and 26. Structure 20, cylinder 22, disk 27 and optical fibers 21 rotate at the same angular velocity.

This configuration works the same way as the configuration of FIG. 1 except light sources 23.1 are stationary on a cylindrical surface 23. As structure 20 rotates, light sources 23.1 align with the first ends 21.1 at certain time interval. At this time interval, light goes through first ends 21.1 such as 21.3 and is emitted from second ends 21.2 such as 21.4.

To achieve much better appearance of each image, an accurate synchronization between light sources 23.1 and first ends 21.1 is done by using sensor 25. The other sensor 26 is used for determining the home position of structure 20.

Similar to the configuration of FIG. 1, each revolution forms one three-dimensional image as FIG. 1b. Still or moving images are formed by subsequent revolutions.

The stationary light sources can be the pixels 28.1 of a curved screen 28 as shown is FIG. 2b. First ends 21.1 will receive light directly from the pixels 28.1 of the curved screen 28. However, curved screens are not well developed therefore we will see an alternative option which is adding another but stationary optical fibers structure.

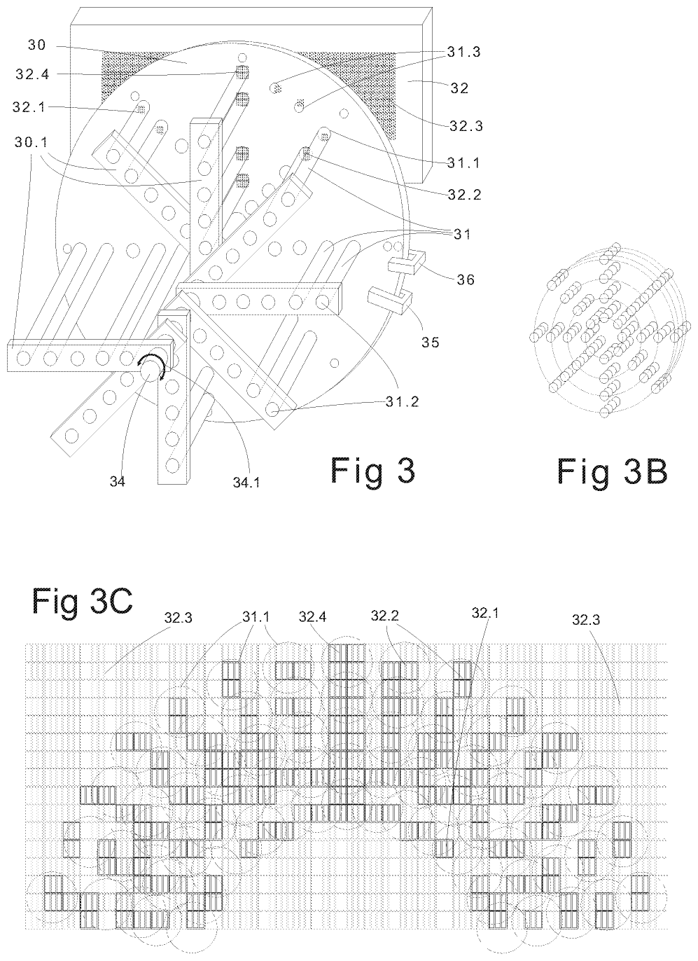

FIG. 3 illustrates an exemplary optical fibers structure rotating around its horizontal axis and stationary light sources which are the pixels of a screen in accordance with the three-dimensional display described herein.

The configuration of FIG. 3 has optical fibers 31 supported by opaque disk 30 and radial pieces 30.1, and they all rotate around axis 34 and in either direction 34.1 at the same angular velocity. The radial pieces 30.1 are spaced axially and radially along axis 34. Optical fibers 31 have first ends 31.1 which receive light directly from the pixels 32.3 of stationary screen 32. The second ends 31.2 emit light to produce a three-dimensional image shown in FIG. 3b. FIG. 3b shows a three-dimensional image where all second ends emit lights. Sensors 35 and 36 are stationary and are used for synchronization and for home position respectively. The use of the pixels of screen 32 is not efficient where most of the pixels are partially aligned with the first ends 31.1, as seen with a smaller size fiber 31.3.

FIG. 3c illustrates an exemplary diameter size of optical fibers which guarantee each optical fiber will receive light from at least one pixel of a screen in accordance with the three-dimensional display described herein.

FIG. 3c shows a way to help utilize more pixels of screen 32. This is done by increasing the diameter size which is actually first end 31.1 of fibers 31 to about twice or more the size of a pixel. This will guarantee that at least one complete pixel is aligned with first end 31.1. For example, one pixel 32.1, two pixels 32.2 and 4 pixels 32.4 are completely aligned with first ends 31.1. Therefore, with the proper control, or software program, of these aligned pixels, a three-dimensional image is obtains using any screen directly.

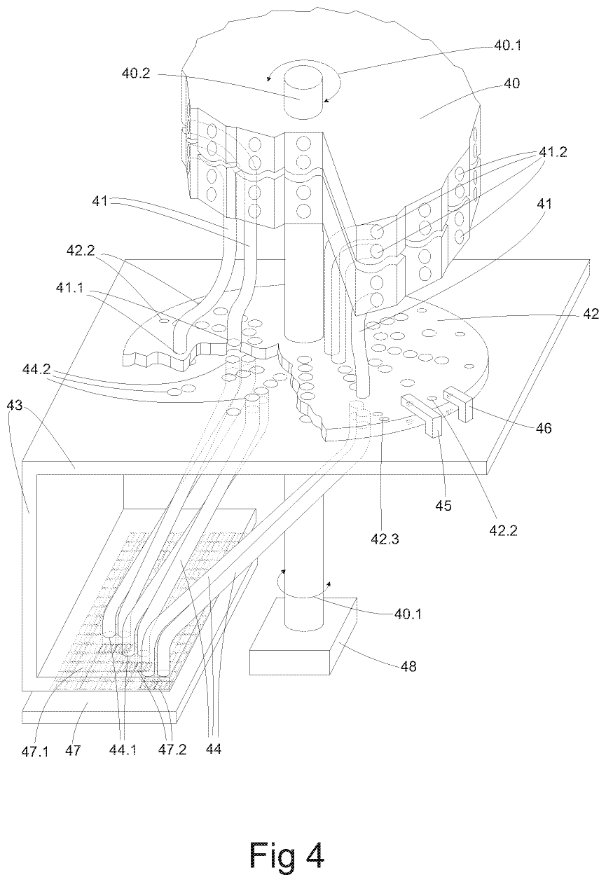

FIG. 4 illustrates an exemplary optical fibers structure rotating around its vertical axis and horizontal stationary light sources receiving light from a second optical fibers structure which receives light from pixels in x-y coordinates of a screen in accordance with the three-dimensional display described herein.

Structure 40 is similar to structure 10 and comprises mainly of optical fibers 41, and rotates around its axis 40.2 in either direction 40.1 by a rotation means 48. Optical fibers 41 have first ends 41.1 which receive light and second ends 41.2 which emit light. Disk 42 is preferably opaque and supports first ends 41.1 and has holes which interrupt the lights of sensors 45 and 46. Structure 40, disk 42 and optical fibers 41 rotate at the same angular velocity.

Second structure 43 is stationary and comprised mainly of optical fibers 44 with end ones 44.1 and end twos 44.2. End ones 44.1 receive lights from pixels 47.1 of screen 47, and re-emit lights from end twos 44.2. Then end twos become the light sources for first ends 41.1 of the rotating structure 40.

The role of second structure 43 is to convert the lights of pixels 47.2 in x-y coordinates to radial coordinates suitable for the rotating structure 40. It can be easily seen the big advantage second structure 43 offers. It is the use of all the pixels of any screen without the need of a specific board such as board 13 of FIG. 1. Consequently, the software program needed with the use of second structure 43 is much simpler that a software program for configurations without second structure 43.

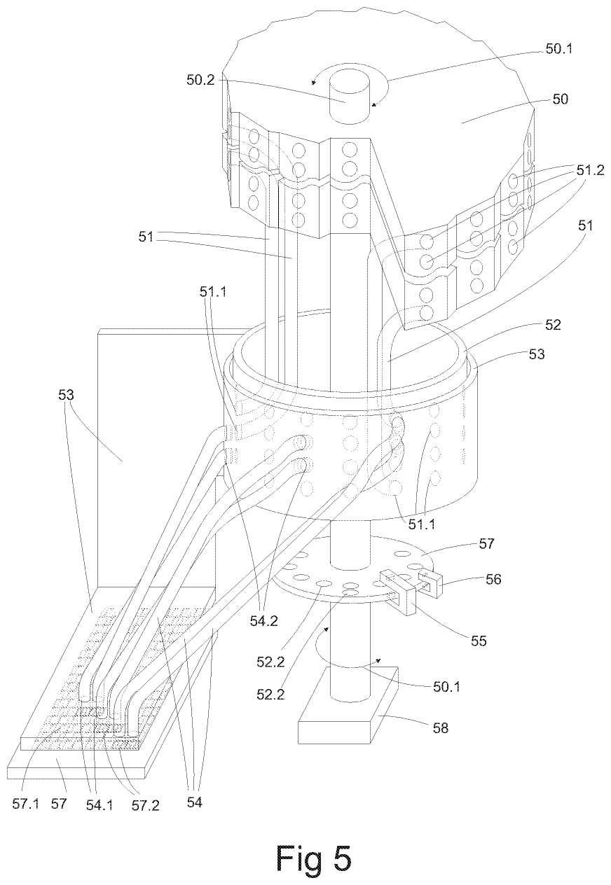

FIG. 5 illustrates an exemplary optical fibers structure rotating around its vertical axis and vertically stationary light sources receiving light from a second optical fibers structure which receives light from pixels in x-y coordinates of a screen in accordance with the three-dimensional display described herein.

Structure 50 is similar to structure 10 and comprises mainly of optical fibers 51, and rotates around its axis 50.2 in either direction 50.1 by a rotation means 58. Optical fibers 51 have first ends 51.1 which receive light and second ends 51.2 which emit light. Cylinder 52 is preferably opaque and supports first ends 51.1. Disk 57 has holes which interrupt the lights of sensors 55 and 56. Structure 50, cylinder 52, disk 57 and optical fibers 51 rotate at the same angular velocity.

Second structure 53 is stationary and comprised mainly of optical fibers 54 with end ones 54.1 and end twos 54.2. End ones 54.1 receive lights from pixels 57.1 of screen 57, and re-emit lights from end twos 54.2. Then end twos become the light sources for first ends 51.1 of the rotating structure 50.

The role of second structure 53 is similar to the role of second structure 43 except that it converts the lights of pixels 57.2 in x-y coordinates to coordinates on a cylinder suitable for the rotating structure 50. Second structure 53 replaces the curved screen which is of course much easier to use only if it well developed.

What is claimed is:

1. A three-dimensional display including:
a structure comprising at least one optical fiber with a first end and a second end;
rotation means providing rotation for said structure; and
at least one light source wherein said first end receives light from said light source when said first end is aligned during a time interval with said light source on each revolution of said structure,
wherein said second end emits light and all lights emitted during each revolution form a three-dimensional image and successive images produced on successive revolutions form still or moving images.

2. Claim 1 wherein said light source is placed on flat surface.

3. Claim 1 wherein said light source is placed on a cylindrical surface.

4. Claim 1 wherein said light source is formed by at least one pixel of at least one screen.

5. Claim 1 further including a second structure comprising at least one optical fiber with end one and end two wherein end one receives light from at least one pixel of at least one screen and said light source receives light from said end two.

6. Claim 1 further including at least one sensor wherein said sensor is used for synchronization between said first end and said light source or said sensor is used for determining the home position of said structure.

7. Claim 2 further including at least one sensor wherein said sensor is used for synchronization between said first end and said light source or said sensor is used for determining the home position of said structure.

8. Claim 3 further including at least one sensor wherein said sensor is used for synchronization between said first end and said light source or said sensor is used for determining the home position of said structure.

9. Claim 4 further including at least one sensor wherein said sensor is used for synchronization between said first end and said light source or said sensor is used for determining the home position of said structure.

10. Claim 5 further including at least one sensor wherein said sensor is used for synchronization between said first end and said light source or said sensor is used for determining the home position of said structure.

11. Claim 1 wherein second end form rows or columns spaced axially and angularly so that each said second end emits light in a unique three-dimensional coordinates.

12. Claim 2 wherein second end form rows or columns spaced axially and angularly so that each said second end emits light in a unique three-dimensional coordinates.

13. Claim 3 wherein second end form rows or columns spaced axially and angularly so that each said second end emits light in a unique three-dimensional coordinates.

14. Claim 4 wherein second end form rows or columns spaced axially and angularly so that each said second end emits light in a unique three-dimensional coordinates.

15. Claim 5 wherein second end form rows or columns spaced axially and angularly so that each said second end emits light in a unique three-dimensional coordinates.

16. Claim 6 wherein second end form rows or columns spaced axially and angularly so that each said second end emits light in a unique three-dimensional coordinates.

17. Claim 7 wherein second end form rows or columns spaced axially and angularly so that each said second end emits light in a unique three-dimensional coordinates.

18. Claim 8 wherein second end form rows or columns spaced axially and angularly so that each said second end emits light in a unique three-dimensional coordinates.

19. Claim 9 wherein second end form rows or columns spaced axially and angularly so that each said second end emits light in a unique three-dimensional coordinates.

20. Claim 10 wherein second end form rows or columns spaced axially and angularly so that each said second end emits light in a unique three-dimensional coordinates.
